(19) United States
(12) Patent Application Publication
(10) Pub. No.: US 2023/0232382 A1
(43) Pub. Date: Jul. 20, 2023

(54) PROCEDURES FOR CORESET SHARING

(71) Applicant: Fraunhofer-Gesellschaft zur Foerderung der angewandten Forschung e.V., Munich (DE)

(72) Inventors: Nithin Srinivasan, Berlin (DE); Baris Göktepe, Berlin (DE); Jasmina McMenamy, Berlin (DE); Sarun Selvanesan, Berlin (DE); Thomas Fehrenbach, Berlin (DE); Thomas Wirth, Berlin (DE); Thomas Schierl, Berlin (DE); Cornelius Hellge, Berlin (DE)

(21) Appl. No.: 18/158,881

(22) Filed: Jan. 24, 2023

Related U.S. Application Data
(63) Continuation of application No. PCT/EP2021/071565, filed on Aug. 2, 2021.

(30) Foreign Application Priority Data
Aug. 3, 2020 (EP) 20189227.0

(51) Int. Cl. H04W 72/0446; H04W 72/0457; H04W 72/0453; H04W 72/23

(52) U.S. Cl. CPC H04W 72/0446; H04W 72/0457; H04W 72/0453; H04W 72/23

(57) ABSTRACT

A wireless communication network, has one or more first user devices, UEs, and one or more second user devices, UEs. The wireless communication network is to configure the first UE with one or more bandwidth parts, BWPs, and with a set of control resource sets, CORESETs, within the BWP in the same slot, and the wireless communication network is to configure the second UE with only a subset from the set of CORESETs.

### CROSS-REFERENCE TO RELATED APPLICATIONS

This application is a continuation of copending International Application No. PCT/EP2021/071565, filed Aug. 2, 2021, which is incorporated herein by reference in its entirety, and additionally claims priority from European Application No. 20189227.0, filed Aug. 3, 2020, which is also incorporated herein by reference in its entirety.

### TECHNICAL FIELD

The present invention concerns the field of wireless communication networks or systems, more specifically, wireless communication networks in which a user device or UE is configured by use of control resource sets, CORESETs. Embodiments concern a use of a same CORESET structure for regular UEs and so-called reduced capability, RedCap, UEs.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄ , which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂ . The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also consist of a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

Mobile communication networks, for example a network like that described above with reference to FIG. 1, for supporting multiple UE types, not all being capable of receiving full carrier bandwidth, and for reducing UE power consumption, may configured a UE to use a so-called bandwidth part. FIG. 2 schematically illustrates the concept of bandwidth parts and illustrates at 170 the overall bandwidth available, as well as two bandwidth parts 172a and 172b having a bandwidth being less than the overall bandwidth 170. A BWP includes a set of continuous resource blocks within the entire bandwidth of the system, and each BWP is associated with a specific numerology, like a sub carrier spacing, SCS, and a respective cyclic prefix. A BWP may be equal or larger than the size of a synchronization sequence, SS, block, also referred to as SSB, and may or may not contain the SSB. A UE is configured with one active sidelink BWP when in connected mode to a gNB, which is the same as the single sidelink BWP used for idle mode or out-of-coverage operation. The subcarrier spacing used on a sidelink is provided in the sidelink BWP configuration or pre-configuration, from the same set of values and associations to frequency ranges as for the Uu interface, e.g., 15, 30, or 60 kHz for FR1, and 60 or 120 kHz for FR2.

Within a BWP a set of physical resources is defined and used for the control data, like the PDCCH. The set of resources is referred to as a Control Resource Set, CORESET. Within the BWP a set of RBs and the set of OFDM symbols define the CORESET in which are located one or more configurable search spaces.

It is noted that the information in the above section is only for enhancing the understanding of the background of the invention and, therefore, it may contain information that does not form known technology that is already known to a person of ordinary skill in the art. Starting from the above, there may be a need for improvements or enhancements for user devices employing CORESETs.

### SUMMARY

According to an embodiment, a wireless communication network may have: one or more first user devices, UEs, and one or more second user devices, UEs, wherein the wireless communication network is to configure the first UE with one or more bandwidth parts, BWPs, and with a set of control resource sets, CORESETs, within the BWP in the same slot, and wherein the wireless communication network is to configure the second UE with only a subset from the set of CORESETs.

Another embodiment may have a user device, UE, for a wireless communication network, wherein the wireless communication network provides one or more bandwidth parts, BWPs, and a plurality of control resource sets, CORESETs, within the BWP, wherein the second UE is configured or preconfigured with only one CORESET of the plurality of CORESETs.

According to another embodiment, a wireless communication network may have: one or more first user devices, UEs, and one or more second user devices, UEs, wherein the wireless communication network is to configure the first UE in a set of time symbols with a set of frequency resources for defining a control resource set, CORESET, and wherein the wireless communication network is to configure the second UE in the set of time symbols with a subset of the frequency resources for defining a partial CORESET.

Another embodiment may have a user device, UE, for a wireless communication network, wherein the wireless communication network provides in a set of time symbols a set of frequency resources defining a control resource set, CORESET, wherein the UE is configured or preconfigured in the set of time symbols with a subset of the frequency resources for defining a partial CORESET.

Another embodiment may have a user device, UE, for a wireless communication network, wherein the wireless communication network provides a set of frequency and time resources defining a monitoring occasion, like a PDCCH monitoring occasion, for transmitting one or more control messages, like a DCI, wherein the UE is to receive a control message across a plurality of monitoring occasions which are offset in time, each monitoring occasion including a part of the control message, and wherein the UE is to combine the received parts of the control message into the complete control message.

Another embodiment may have a wireless communication network, comprising one or more above inventive user devices, UEs, for a wireless communication network, wherein the wireless communication network provides a set of frequency and time resources defining a monitoring occasion, like a PDCCH monitoring occasion, for transmitting one or more control messages, like a DCI, wherein the UE is to receive a control message across a plurality of monitoring occasions which are offset in time, each monitoring occasion including a part of the control message, and wherein the UE is to combine the received parts of the control message into the complete control message.

According to another embodiment, a wireless communication network may have: one or more first user devices, UEs, and one or more second user devices, UEs, wherein the wireless communication network is to configure the first UE with a set of frequency resources defining a first control resource set, CORESET, such that the first CORESET is located at an arbitrary set of time symbols within a slot, and wherein the wireless communication network is to configure the second UE with a set of frequency resources defining a second control resource set, CORESET, such that the second CORESET is located at a predefined set of time symbols within a slot, e.g., at the first OFDM symbols of the slot, and/or at a configured or preconfigured set of time symbols within a slot where the set of time symbols is equal across all CORESET configurations.

According to another embodiment, a method for operating wireless communication network comprising one or more first user devices, UEs, and one or more second user devices, UEs, may have the steps of: configuring the first UE with one or more bandwidth parts, BWPs, and with a set of control resource sets, CORESETs, within the BWP in the same slot, and configuring the second UE with only a subset from the set of CORESETs.

According to another embodiment, a method for operating a user device, UE, for a wireless communication network, wherein the wireless communication network provides one or more bandwidth parts, BWPs, and a plurality of control resource sets, CORESETs, within the BWP, may have the step of: configuring or preconfiguring the UE with only one CORESET of the plurality of CORESETs.

According to still another embodiment, a method for operating wireless communication network, comprising one or more first user devices, UEs, and one or more second user devices, UEs, may have the steps of: configuring the first UE in a set of time symbols with a set of frequency resources for defining a control resource set, CORESET, and configuring the second UE in the set of time symbols with a subset of the frequency resources for defining a partial CORESET.

According to another embodiment, a method for operating a user device, UE, for a wireless communication network, wherein the wireless communication network provides in a set of time symbols a set of frequency resources defining a control resource set, CORESET, may have the step of: configuring or preconfiguring the UE in the set of time symbols with a subset of the frequency resources for defining a partial CORESET.

According to another embodiment, a method for operating a user device, UE, for a wireless communication network, wherein the wireless communication network provides a set of frequency and time resources defining a monitoring occasion, like a PDCCH monitoring occasion, for transmitting one or more control messages, like a DCI, may have the steps of: receiving a control message, with the UE, across a plurality of monitoring occasions which are offset in time, each monitoring occasion including a part of the control message, and combining, with the UE, the received parts of the control message into the complete control message.

According to another embodiment, a method for operating a wireless communication network comprising one or more first user devices, UEs, and one or more second user devices, UEs, may have the steps of: configuring the first UE with a set of frequency resources defining a first control resource set, CORESET, such that the first CORESET is located at an arbitrary set of time symbols within a slot, and configuring the second UE with a set of frequency resources defining a second control resource set, CORESET, such that the second CORESET is located at a predefined set of time symbols within a slot, e.g., at the first OFDM symbols of the slot, and/or at a configured or preconfigured set of time symbols within a slot where the set of time symbols is equal across all CORESET configurations.

Another embodiment may have a non-transitory digital storage medium having stored thereon a computer program for performing the above inventive methods when said computer program is run by a computer.

### BRIEF DESCRIPTION OF THE DRAWINGS

Embodiments of the present invention are now described in further detail with reference to the accompanying drawings, in which:

FIGS. 1a-b is a schematic representation of an example of a terrestrial wireless network, wherein FIG. 1(a) illustrates a core network and one or more radio access networks, and FIG. 1(b) is a schematic representation of an example of a radio access network RAN;

FIG. 2 schematically illustrates the concept of bandwidth parts, BWPs;

FIG. 3 is a schematic representation of a wireless communication system including a transmitter, like a base station, one or more receivers, like user devices, UEs, and one or more relay UEs for implementing embodiments of the present invention;

FIG. 4 illustrates an embodiment of a first aspect of the present invention;

FIG. 5 illustrates an embodiment of a second aspect of the present invention;

FIGS. 6a-b illustrates an example for the frequencyDomainResourcesOffset field in a PDCCH-Config IE;

FIG. 7a-b illustrates an example for the DMRSOffset field in a PDCCH-Config IE;

FIG. 8 illustrates an example for the ControlResourceSetRedCapOffset IE;

FIG. 9 illustrates an example for a ControlResourceSet IE including the field noCCEcoreset;

FIGS. 10a-b illustrates embodiments for an optimized interleaving of PDCCH candidates of a first UE, like a eMBB IE, and PDCCH candidates of a second UE, like a RedCap UE;

FIG. 11 illustrates an embodiment of a third aspect of the present invention;

FIG. 12 depicts an example of a specification of a timing offset for DCI formats for a UE-specific search space;

FIG. 13 illustrates an embodiment of a fourth aspect of the present invention; and

FIG. 14 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

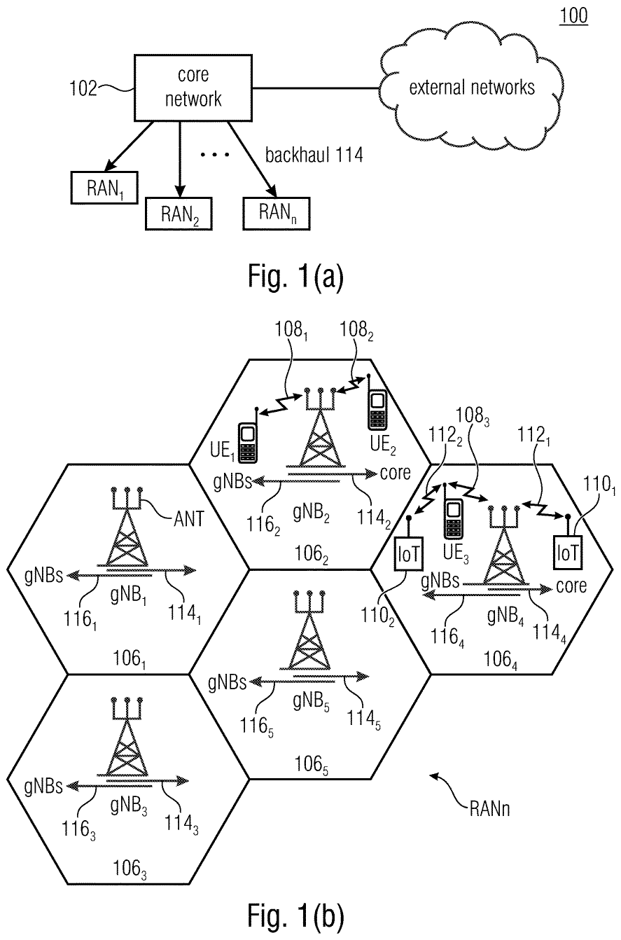

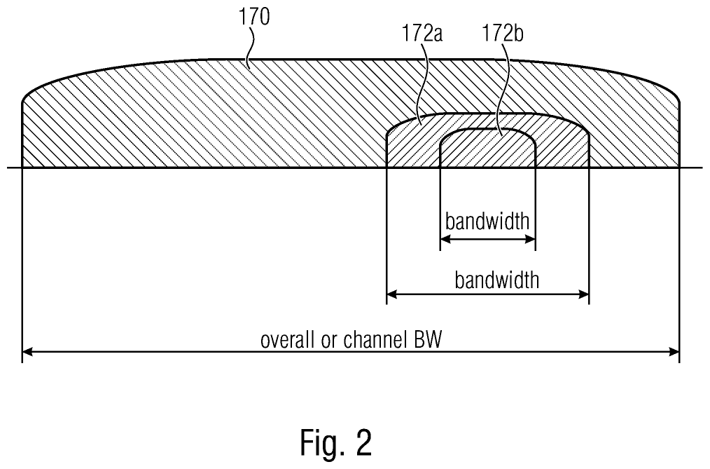

In a wireless communications network, like the one described above with reference to FIG. 1, several types or categories of user devices or UEs may be employed. For example, there are so-called full-powered UEs that are provided with a permanent power supply, like vehicular UEs obtaining power from a vehicle's battery. For such UEs, energy consumption is not an issue. Other user devices or UEs, like hand-held UEs, do not have a permanent power supply but are battery driven so that energy consumption needs to be considered. Also, there may be so-called Reduced Capability, RedCap, user devices or UEs having less capabilities when compared to other UEs, e.g., to enhanced Mobile BroadBand, eMBB, UEs. Embodiments referring to RedCaps may also relate to power-saving UEs, that may, for example to save power, have (temporarily) an operating mode in which a low bandwidth is processed whilst in other operating modes the full bandwidth is processed. The capabilities concerned may include a maximum bandwidth such a UE may support. For example, when operating in Frequency Range 1, FR1, the UE may support a maximum of 20 MHz bandwidth, and when operating in Frequency Range 2, FR2, the UE may support up to 100 MHz bandwidth. Further requirements of a RedCap UE may include one or more of the following:
Device complexity: reduced costs and complexity when compared to high-end eMBB and Ultra Reliable Low Latency Communication, URLLC, devices.
Device size: for most use cases device design with compact form factor is decried.
Deployment scenarios: support of all FR1/FR2 bands for Frequency Division Duplexing, FDD, and Time Division Duplexing, TDD.

RedCap UEs may comprise also industrial sensors or wearables using SL communication to communicate with other UEs directly. For example, wearables may use SL communication to communicate with cars or other wearables directly.

As mentioned above, mobile communication networks, like the one described above with reference to FIG. 1, may employ CORESETs, and respective UEs operating in the network may be configured or preconfigured with a CORESET configuration. A CORESET configuration information element, IE, may be used for providing a set of resource blocks, RBs, which lie within a BWP of the UE. Also one or more search spaces are defined which determine a frequency of the CORESET and the number of PDCCH candidates within the CORESET resources which are to be monitored by a UE. The smallest resource unit of a CORESET is designated as a resource element group, REG, and spans one resource block, RB, in frequency and one OFDM symbol in the time domain. The REGs may be bundled into so-called REG bundles having a size of 2, 3 or 6. When employing the interleaving option for a CORESET, the REG bundles are distributed over the entire CORESET. Moreover, 6 REGs are bundled into so-called control channel elements, CCEs. Dependent on the channel conditions the transmitter, like the gNB or a UE sending over a sidelink to a receiving UE, may encode the DCI or the SCI using different code rates, i.e., different aggregation levels, AL. The aggregation level AL-1 corresponds to one CCE, and the aggregation level AL-8 corresponds to eight CCEs.

A PDCCH may be confined to one CORESET and transmitted with its own demodulation reference signal, and a CORESET DMRS sequence is generated as follows:

The UE shall assume the reference-signal sequence rₗ(m) for OFDM symbol l is defined by

$${r}_{l} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) .$$

where the pseudo-random sequence c(i) is defined in clause 5.2.1. The pseudo-random sequence generator shall be initialized with

cᵢₙᵢₜ=(2¹⁷(N_{symbol}^{slot}n_{s,f}^{μ}+l+1)(2N_{ID}+1)+2N_{ID})mod2³¹

where l is the OFDM symbol number within the slot, n_{s,f}^{μ} is the slot number within a frame, and
N_{ID} ∈{0,1, . . . , 65535} is given by the higher-layer parameter pdcch-DMRS-ScramblingID if provided
N_{ID}=N_{ID}^{cell} otherwise.

Dependent on the size of a BWP, a BWP may be divided into smaller subbands, according to the table below, which allows subband based processing or subband-based reporting.

< 38.214-Table 5.2.1.4-2: Configurable subband sizes >

| Bandwidth part (PRBs) | Subband size (PRBs) |
|---|---|
| <24 | N/A |
| 24-72 | 4, 8 |
| 73-144 | 8, 16 |
| 145-275 | 16, 32 |

While the above-described concept of employing bandwidth parts and CORESETs within such bandwidth parts operates well for UEs being capable to operate over the entire bandwidth of the bandwidth part, other UEs, like the above-described RedCap UEs, may not have this capability, i.e., may be limited to an operation only within a certain maximum bandwidth of for example 20 MHz in FR1 and up to 100 MHz in FR2. This has implications for many procedures used for current UEs capable of operating the entire bandwidth of a bandwidth part like eMBB UEs. The problem with conventional approaches is that UEs not operating over the entire bandwidth part, like RedCap UEs having a limited bandwidth, do not support large CORESETs spanning a bandwidth larger than the maximum bandwidth the UE is capable to handle. Conventionally, this issue is addressed by scheduling specific or special CORESETs for RedCap UEs, however, this negatively affects the scheduling flexibility of a base station or gNB as the number of CORESTs that have to be scheduled increases which may have especially an impact for the scheduling flexibility of eMBB UEs.

The present invention addresses this issue and provides, in accordance with various aspects, approaches for solving the above issue and improving the scheduling flexibility for the gNB.

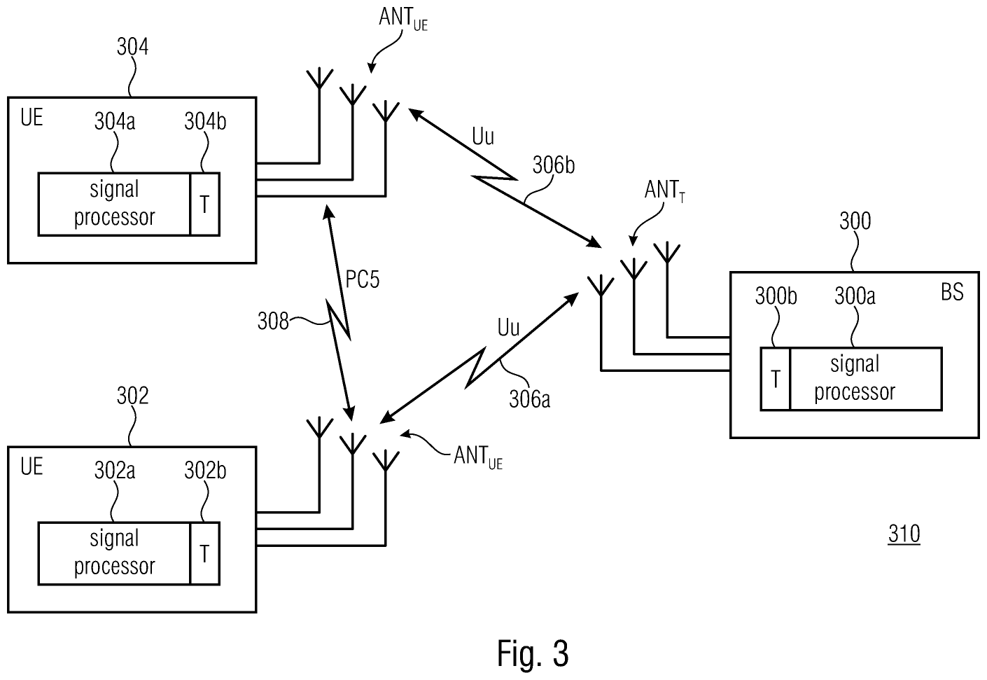

Embodiments of the present invention may be implemented in a wireless communication system as depicted in FIG. 1 including base stations and users, like mobile terminals or IoT devices. FIG. 3 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink, SL, interface. When the UEs are not served by the base station or are not connected to a base station, for example, they are not in an RRC connected state, or, more generally, when no SL resource allocation configuration or assistance is provided by a base station, the UEs may communicate with each other over the sidelink, SL. The system or network of FIG. 3, the one or more UEs 302, 304 of FIG. 3, and the base station 300 of FIG. 3 may operate in accordance with the inventive teachings described herein.

First Aspect—RedCap UE using CORESET of on-a RedCap UE

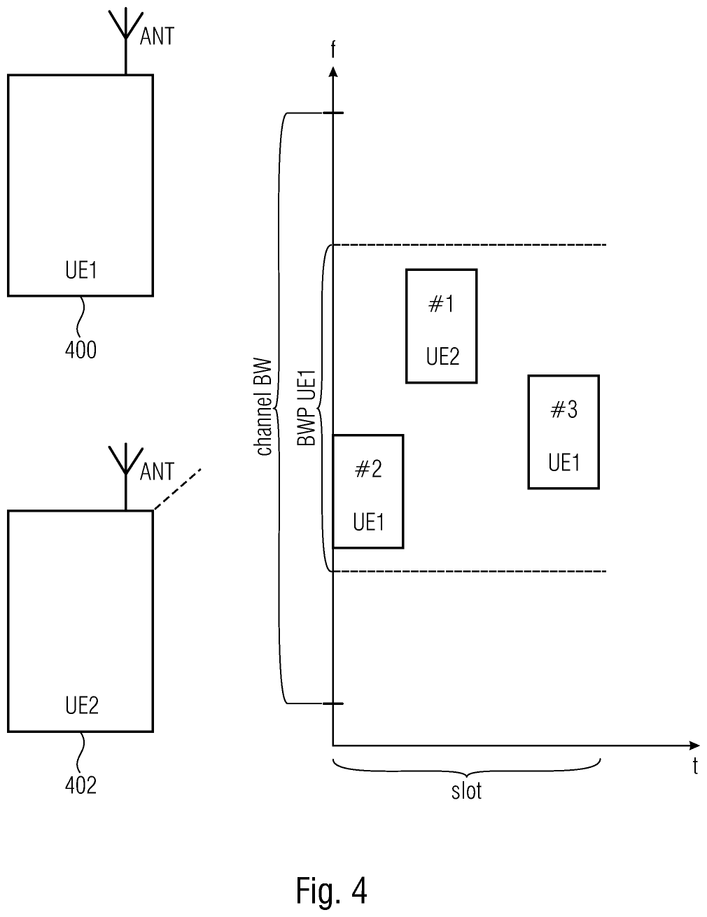

In accordance with embodiments of a first aspect of the present invention, an approach is provided in accordance with which a first UE, like a eMBB UE, is configured or preconfigured with a group or a set of CORESETs in a BWP in the same slot, while a second UE of a different type, like a RedCap UE, is configured with only a subset from the set of CORESETs taken from the group of CORESETs associated with a first UE. FIG. 4 illustrates an embodiment of the first aspect of the present invention, more specifically, the wireless communication network including one or more first user devices 400 or UE1, and one or more second user devices, 402 or UE2. In FIG. 4, on the right hand side, the channel bandwidth is illustrated schematically, and within the channel BW, the wireless communication network configures UE1 with one or more BWPs. FIG. 4 illustrates a single BWP, however, in accordance with other embodiments within the channel bandwidth also multiple BWPs may be configured for UE1. Moreover, within the BWP for UE1, a set of CORESETs #1 to #3 are defined. UE1 is a user device capable of operating at least over the entire bandwidth of the BWP indicated in FIG. 4, while UE2 may be a RedCap UE capable of operating only in a frequency range or supporting only a maximum bandwidth being less than the bandwidth of the BWP associated with UE1. In other words, when compared to UE2, UE1 is capable to operate in a frequency range or support a maximum bandwidth that is larger than the frequency range or maximum bandwidth supported by the RedCap UE2.

In accordance with the first aspect of the present invention, to address the above-summarized drawbacks in conventional approaches, rather than defining for the RedCap UE2 specific CORESETs in addition to those specified for UE1, among the plurality of CORESETs #1 to #3, i.e., the set of CORESETs, defined for UE1, a subset thereof, e.g., one or more from the set, the subset unselecting at least one from the set of CORESETs, is used for UE2, like CORESET #1 in the embodiment depicted in FIG. 4. FIG. 4, thus illustrates an example where only one CORESET is used but, however, in the given example, also a single different CORESET or a combination of any two CORESETs may be used. With regard to CORESETs #1 to #3, the CORESETs may be located at multiple, different frequency locations. For example, a so-called basic CORESET, e.g. CORESET #1, may form a basis for other CORESETs that may be located in one or more subbands, e.g., in multiple frequency locations, e.g. CORESETs #2 and #3. These other CORESETs may have exactly the same structure as the basic CORESET, e.g., a same bandwidth and/or same time symbols or the like. Further this set of CORESETs may be processed as a single CORESET by UE1. It is to be noted, that a position of the CORESETs with respect to each other, i.e., an order or sequence and a frequency spacing may be symmetrically or asymmetrically, adjacent to one another such as configuring a UE with adjacent CORESETs or spaced apart from one another, e.g., that between different CORESETs for a single UE are CORESET for another UE may be present.

The eMBB UE1, which operates in the unlicensed band or in the licensed band, is configured with the set of CORESETs #1 to #3 within its BWP, and the RedCap UE1 is configured with only one of the set of CORESETs #1 to #3. For example, the first UE may be configured with the set of CORESETs within the BWP in the same slot by a CORSET configuration for a basic CORESET, like CORSET #1, which defines, among other parameters, a bandwidth of the basic CORESET and a parameter indicating a plurality of frequency monitoring locations, like frequency bands, at which the basic CORESET exists. In FIG. 4 it is assumed that two further frequency monitoring locations are defined in the configuration resulting in CORESETs #2 and #3. As discussed, CORESETs #2 and #3 may have the same structure as CORESET#1 being a basic CORESET, i.e. they may have a same width and/or height in the frequency domain and/or same position in time. For example, only their positions in frequency are different. The second UE is capable to operate in a first frequency range or supports a first maximum bandwidth that is equal to or larger than the bandwidth of the basic CORESET. For example, different UEs may consider different instances of time, e.g., between a last and a first location and may use a same corresponding frequency location. For example, the basic CORESET and a plurality of frequency locations may comprise the set of CORESETs.

That is, to configure the UE1 with the set of CORESETs within the BWP in the same slot, the wireless communication network may provide a CORSET configuration for a basic CORESET, the CORSET configuration defining a bandwidth of the basic CORESET and a parameter indicating a plurality of frequency monitoring locations, like frequency bands, e.g., sub-bands or a set of sub-bands or frequency ranged, at which the basic CORESET exists. UE2 may be capable to operate in a first frequency range or support a first maximum bandwidth, with the first frequency range or the first maximum bandwidth being equal to or larger than the bandwidth of the basic CORESET and at most a multiple of the frequency band however less than the total number of frequency monitoring locations. Thus, in an example, the RedCap UE may support the full basic CORESET however not the multiple frequency monitoring locations.

Although referring to a single reduced category only, different subcategories of the RedCap UE may be implemented, leading to different bandwidth capabilities. The basic CORESET for the RedCap UEs may be, in an embodiment, the smallest common denominator for all RedCap UEs, i.e., it may be handled with all categories. In other words, a third UE with even less bandwidth than the second UE may be implemented. The network may configure the basic CORESET such that it fits into the smallest bandwidth. A number of supported categories may also be greater than 3, e.g., at least 4, at least 5 or higher. One or more third user devices, UEs, may be capable to operate in a third frequency range or support a third maximum bandwidth being smaller than the first frequency range or bandwidth, with the third frequency range or the third maximum bandwidth being equal to or larger than the bandwidth of the basic CORESET but not larger than the frequency band.

A UE may be configured with a single or with multiple CORESETs. A UE being configured with multiple CORESETs at different frequency locations, e.g., the basic CORESET and at least one additional CORESET, may regard, evaluate or consider this set of CORSETs as a single, combined CORESET. That is, the UE may combine or aggregate information obtained from the set or subset of CORESETs.

In accordance with embodiments of the first aspect, when a plurality of RedCap UEs are provided, they may be configured with the same single CORESET or with different CORESETs out of the set of CORESETs #1 to #3 provided for UE1 in FIG. 4.

Embodiments according to the first aspect provide for a wireless communication network, comprising:

one or more first user devices, UEs, and

one or more second user devices, UEs,

wherein the wireless communication network is to configure the first UE with one or more bandwidth parts, BWPs, and with a set of control resource sets, CORESETs, within the BWP in the same slot, and

wherein the wireless communication network is to configure the second UE with only a subset from the set of CORESETs.

Embodiments according to the first aspect provide for a wireless communication network, wherein the set of CORESETs forms a combined CORESET.

Embodiments according to the first aspect provide for a wireless communication network, wherein the wireless communication network is to configure a plurality of second UEs with the same CORESET or with different CORESETs.

Embodiments according to the first aspect provide for a wireless communication network, wherein

to configure the first UE with the plurality of control resource sets, CORESETs, within the BWP in the same slot, the wireless communication network is to provide a CORSET configuration for a basic CORESET, the CORSET configuration defining a bandwidth of the basic CORESET and a parameter indicating a plurality of frequency monitoring locations, like frequency bands, e.g., sub-bands, at which the basic CORESET exists, and

the second UE is capable to operate in a first frequency range or supports a first maximum bandwidth, with the first frequency range or the first maximum bandwidth being equal to or larger than the bandwidth of the basic CORESET and at most the frequency band.

Embodiments according to the first aspect provide for a wireless communication network, wherein the basic CORESET and a plurality of frequency locations comprise the set of CORESETs.

Embodiments according to the first aspect provide for a wireless communication network, wherein one or more third user devices, UEs, are capable to operate in a third frequency range or supports a third maximum bandwidth being smaller than the first frequency range or bandwidth, with the third frequency range or the third maximum bandwidth being equal to or larger than the bandwidth of the basic CORESET but not larger than the frequency band.

Embodiments according to the first aspect provide for a wireless communication network, wherein the first UE is capable to operate in a second frequency range or supports a second maximum bandwidth, the second frequency range or second maximum bandwidth being larger than the first frequency range or the first maximum bandwidth.

Embodiments according to the first aspect provide for a user device, UE, for a wireless communication network, wherein the wireless communication network provides one or more bandwidth parts, BWPs, and a plurality of control resource sets, CORESETs, within the BWP,

wherein the second UE is configured or preconfigured with only one CORESET of the plurality of CORESETs.

Embodiments according to the first aspect provide for a user device, wherein the UE is capable to operate in a first frequency range or supports a first maximum bandwidth, the first frequency range or first maximum bandwidth being less than a second frequency range or a second maximum bandwidth of one or more further UEs configured with the plurality of CORESETs within the BWP.

Embodiments according to the first aspect provide for a method for operating wireless communication network comprising one or more first user devices, UEs, and one or more second user devices, UEs, the method comprising:

configuring the first UE with one or more bandwidth parts, BWPs, and with a set of control resource sets, CORESETs, within the BWP in the same slot, and

configuring the second UE with only a subset from the set of CORESETs.

Embodiments according to the first aspect provide for a method for operating a user device, UE, for a wireless communication network, wherein the wireless communication network provides one or more bandwidth parts, BWPs, and a plurality of control resource sets, CORESETs, within the BWP, the method comprising:

configuring or preconfiguring the UE with only one CORESET of the plurality of CORESETs.

### Second Aspect—CORESET Sharing/Partial CORESETs

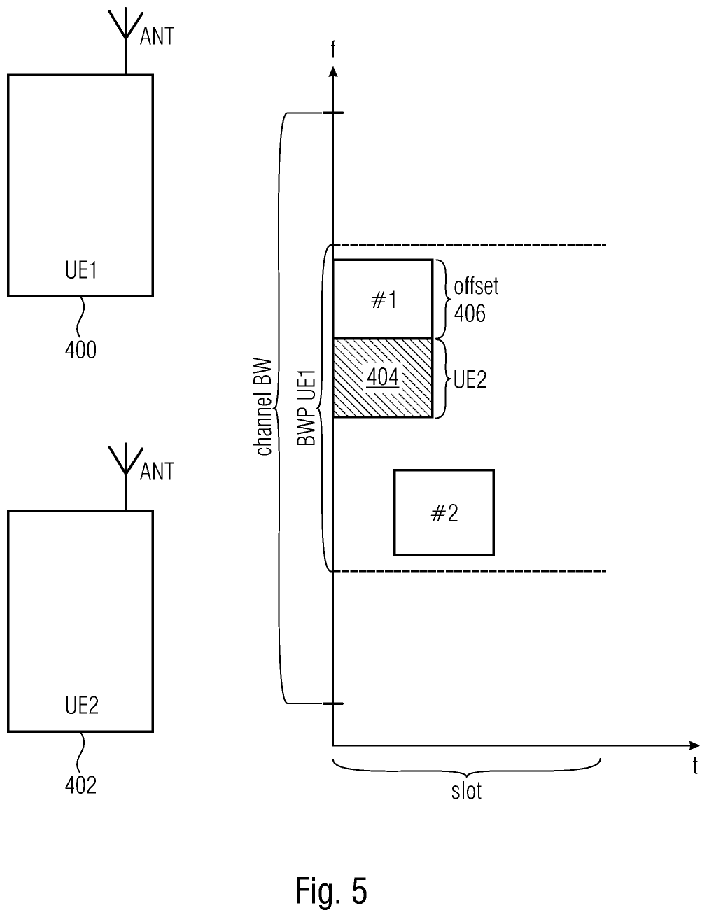

In accordance with embodiments of a second aspect of the present invention, CORESETs may be shared among a first type of UE operating over a first bandwidth and by UEs operating over a second, smaller bandwidth. FIG. 5 illustrates an embodiment of the second aspect of the present invention illustrating a wireless communication network and two types of UEs, namely UE1 and UE2, in a similar way as explained above with reference to FIG. 4. UE1 may be a first type of UE, like a eMBB UE, operating over a first frequency range or supporting a first bandwidth, while UE2 may be a RedCap UE operating only over a smaller bandwidth or a smaller frequency range. Again, it is assumed that the system or network has a channel bandwidth within which one or more BWPs for UE1 are defined. FIG. 5, like FIG. 4 illustrates only a single BWP, however, also more than one BWP may be defined. Within the BWP, respective CORESETS #1 and #2 are configured for UE1, however, also more or less CORESETs may be employed. For example, the first UE may be configured with the CORESETs #1 and #2 as described above with reference to FIG. 4 using a basic CORESET configuration existing at a plurality of frequency monitoring locations. Thus, the first UE is configured in a set of time symbols, like the slot indicated in FIG. 5, with a set of frequency resources defining the CORESETs. As shown in FIG. 4, the CORESETs may be in the same column and of same size, if multiple frequency monitoring locations are used. However, the scenario shown in FIG. 5 is enabled by configuring two different CORESETs (up to 4 or any other number).

To address the above discussed issue with conventional approaches employing CORESETs specifically provided for UE2, in accordance with embodiments of the second aspect of the present invention, such specific CORESETs are avoided. Rather, UE2 is configured in the slot with a subset of the frequency resources of a CORESET provided for UE1 thereby defining a partial CORESET 404 which, in the embodiment of FIG. 5 is part of CORESET #1 of UE1. In other words, in accordance with the second aspect of the present invention, UE2 is provided with a CORESET which is completely confined within the BWP of UE1, more specifically, within a CORESET of UE1. In other words, in accordance with embodiments of the second aspect of the present invention, a RedCap UE, like UE2 in FIG. 5, shares a CORESET with an eMBB UE, like UE1 in FIG. 5, and, hence, the RedCap UE may be provided with a CORESET which is not completely confined within its maximum operating bandwidth or BWP. The RedCap UE may be provided with the information on the structure of the CORESET or in a further embodiment it may be provided only with information on the structure that lies within its CORESET. In accordance with embodiments, also more than one RedCap UE may be provided, and for the different RedCap UEs the same or different partial CORESETs 404 may be defined.

In accordance with further embodiments, the UE2 may be provided with information about the entire structure of the CORESET #1 and the frequency monitoring locations at which the partial CORESET 404 to be used by UE2 is defined. For example, for configuring UE2 with the subset of the frequency resources or the partial CORESET, the wireless communication system may signal to UE2 information describing the partial CORESET by signaling all parameters of the CORSET and where the partial CORESET is located within the CORESET, e.g. by using an offset relative to a BWP of the first UE, or an offset relative to the starting point of the CORESET. In accordance with further embodiments, UE2 may only be provided with information about the actual structure of the partial CORESET 404. For example, only parameters of the partial CORESET and additional parameters used to derive the structure of the partial CORESET may be signaled, e.g. an offset of a first Control Channel Element, CCE, of the partial CORESET, and/or a DMRS offset, or an offset of the first RB of the partial CORESET.

### Signaling of the Partial CORESET: CORESET Offset

A CORESET configuration may be provided either through system information, e.g., in case of a common CORESET, or through dedicated signaling, e.g., in case of a UE-specific CORESET. In accordance with embodiments, UE-specific CORESETs are considered that that are shared between the eMBB UE1 and the RedCap UE2 in FIG. 5.

In the CORESET configuration, the frequency resources of the CORESET may be indicated, for example by a number of bits of which each bit corresponds to 6 RBs forming an RB group, where the first RB group may be the first RB group within a CORESET. Conventionally, this may be signaled by the frequencyDomainResources field within an existing ControlResourceSet IE, e.g., in the IE PDCCH-Config. In accordance with embodiments of the second aspect of the present invention, an additional field, like a frequencyDomainResourcesOffset field, may be provided in the ControlResourceSet IE, like in the IE PDCCH-Config, for indicating an offset 406 of the first RB of the partial CORESET 404 to the first RB of the CORESET #1 within which the partial CORESET 404 is provided, as is illustrated in FIG. 5. The offset 406 may indicated as a number of RBs or as a number of RB groups.

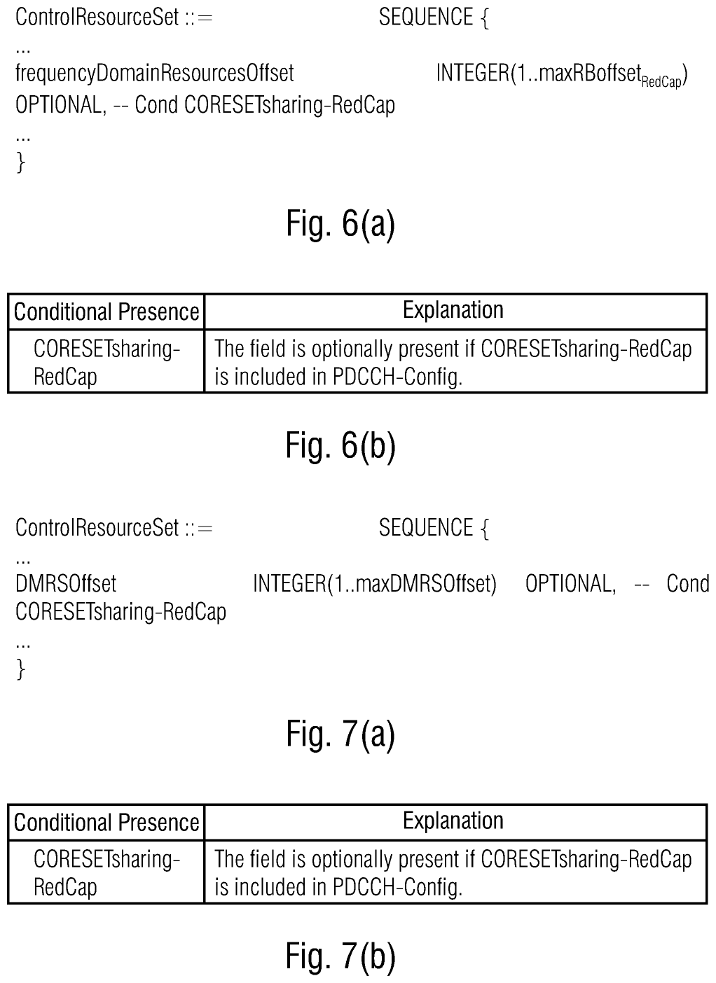

FIG. 6(a) illustrates an example for the frequencyDomainResourcesOffset field. Here, maxRBoffset_{RedCap} is a difference in the number of RBs or RB groups between the number of RBs or RB groups in the BWP where CORESET#n is located and the number of RBs/RB groups in the BWP of the RedCap UE. In other embodiments, only RBoffset_{RedCap} within the existing ControlResourceSet IE may be used to indicate the RB level offset in the units of RB or RB groups from the first RB/group RB of the BWP where CORESET#n is located to the first RB of RedCap BWP. When the field RBoffset_{RedCap} is absent, the UE may apply the value 0.

As is illustrated in FIG. 6(b), the additional parameter or field may be conditionally present in case a field CORESETsharing_{Redcap} is also included in the configuration, which indicates whether the cell is configured with sharing of a CORESET between a RedCap UE and a non-RedCap UE.

### Signaling of Partial CORESET: DMRS Offset

In accordance with further embodiments of the present invention, UE2 is only provided with a configuration of the partial CORESET 404, i.e., the configuration only indicates the partial CORESET 404 without any further information about the structure outside the partial CORESET, i.e., UE2 has no knowledge about the bandwidth part of UE1 or the CORESET #1 within which the partial CORESET 404 is arranged. Non-interleaved CORESETs, the substructure within the partial CORESET 404 is equivalent to the structure of the CORESET #1, however, the DMRS that needs to be provided together with a CORESET to enable UE1 to demodulate a PDCCH does not match. Therefore, in accordance with embodiments of the second aspect of the present invention, a DMRS offset may be signaled, similar to the above-mentioned CORESET offset, so as to enable UE2 to reconstruct the part of the DMRS that falls into the partial CORESET 404. For example, the offset may be obtained by using in the above indicated, conventional formula for the DMRS sequence generation as starting subcarrier “m” not a the starting subcarrier of CORSET #1, but the first subcarrier of the partial CORESET 404.

In accordance with embodiments of the second aspect of the present invention, an additional field, like a DMRSOffset field, may be provided in the ControlResourceSetIE, like in the IE PDCCH-Config. FIG. 7(a) illustrates an example for the DMRSOffset field. Here, maxDMRSOffset indicates the maximum supported DMRS offset. In other embodiments, only DMRSoffset within the existing ControlResourceSet IE may be used to indicate the m offset. When the DMRSoffset is absent, the UE may apply the value 0.

As is illustrated in FIG. 7(b), the additional parameter or field may be conditionally present in case a field CORESETsharing_{RedCap} is also included in the configuration, which indicates whether the cell is configured with sharing of a CORESET between a RedCap UE and a non-RedCap UE.

### Signaling of Partial CORESET: CORESET Offset Information Element

In accordance with further embodiments of the second aspect of the present invention, an information element, IE, may be used which contains pairs of CORESET IDs and corresponding offsets, for example as a list. The offsets may be the above-mentioned CORESET offsets or the above-mentioned DMRS offsets.

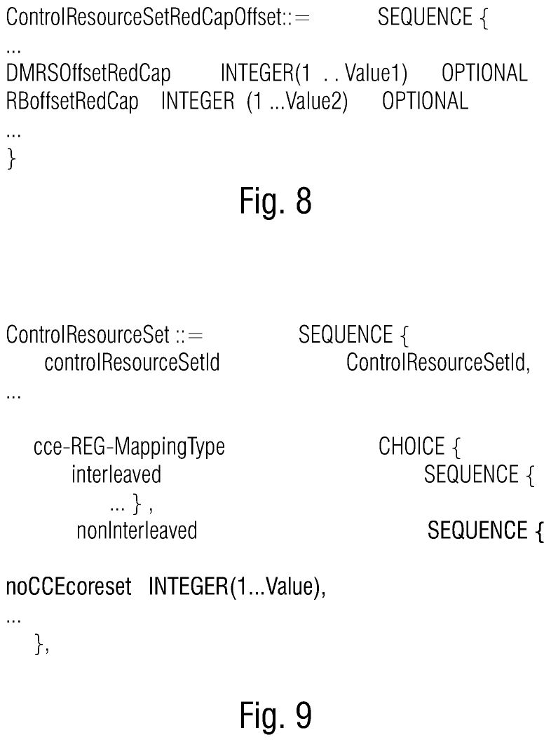

FIG. 8 illustrates an example for the ControlResourceSetRedCapOffset IE that may be used signaling the above-mentioned CORESET offsets and DMRS offset.

### Handling of REG Bundles Lying Outside of the Partial CORESET

In accordance with embodiments of the present invention, in case a PDCCH candidate described by a search space configuration includes a REG bundle which lies fully or partially outside the partial CORESET 404, the UE2, in accordance with embodiments of the second aspect of the present invention may drop the PDCCH candidate or may try decoding without the REG bundles outside the partial BWP 404, for example in case the number of REG bundles within the partial CORESET 404 exceeds a predefined number or threshold.

FIG. 9 illustrates an example for a ControlResourceSet IE including the field noCCEcoreset defining the number of CCEs of the partial CORESET or of the entire CORESET.

Search Spaces Confined within the Partial CORESET

In accordance with yet further embodiments of the second aspect of the present invention, for non-interleaved CORESETs, a hashing function for mapping the PDCCH candidates is selected such that the PDCCH candidates are within the partial CORESET 404. For example, a number of CCEs of the entire CORESET #1 may be set to the number of CCEs in the partial CORESET 404. In accordance with embodiments, a CCE offset or the number of CCEs of the partial CORESET may be signaled to make sure the relevant CCEs are within the partial CORESET 404.

### Partial CORESET Interleaving Function

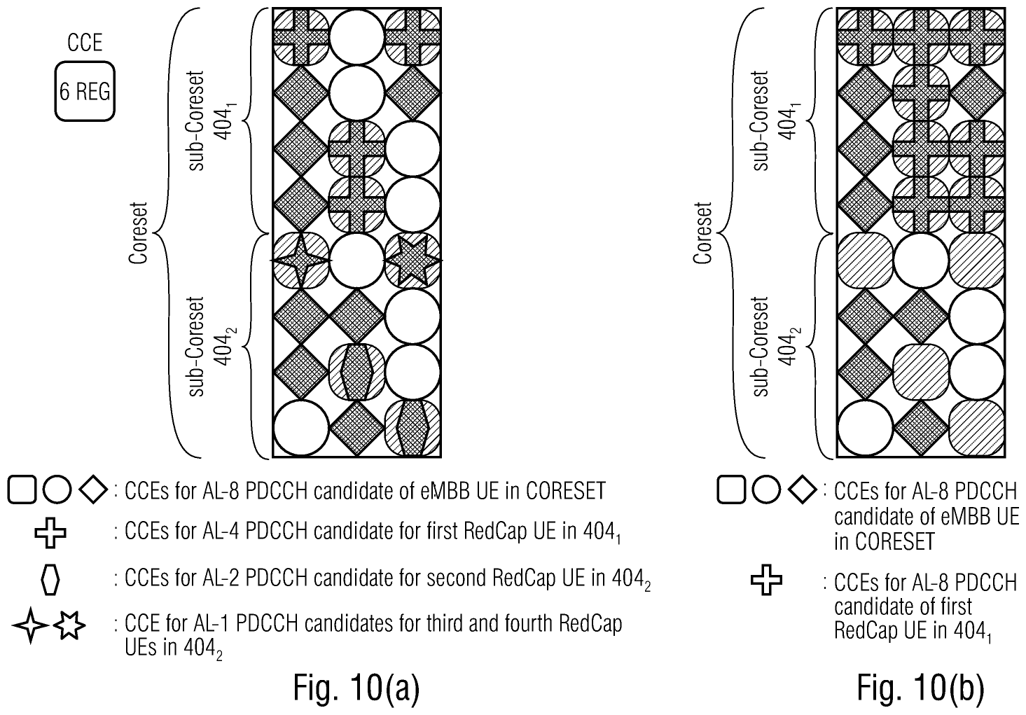

In accordance with further embodiments of the second aspect of the present invention, an optimized interleaver for the one or more partial CORESETs is provided, which ensures that PDCCH candidates always lie within the partial CORESETs while at the same time minimizing an impact on the PDCCH candidates of the entire CORESET. FIG. 10 illustrates embodiments for an optimized interleaving of PDCCH candidates of UE1, like a eMBB IE, and PDCCH candidates of UE2, like a RedCap UE. FIG. 10 assumes AL-8 PDCCH candidates for UE1 and the CCEs for three PDCCH candidates of UE1 in the CORESET are illustrated in FIG. 10. In FIG. 10(a) it is further assumed that a first RedCap UE uses a first partial CORESET or sub-CORSET 404₁, while a second RedCap UE, a third RedCap UE and a fourth RedCap UE use a second partial CORESET or sub-CORSET 404₂. FIG. 10(a) assumes an AL-4 PDCCH candidate of the first RedCap UE, an AL-2 PDCCH candidate of the second RedCap UE, and AL-1 PDCCH candidates of the third and fourth RedCap UEs. FIG. 10(b) assumes an AL-8 PDCCH candidate of the first RedCap UE.

The wireless communication network provides the one or more first PDCCH candidates for UE1, and each first PDCCH candidate is to be transmitted on one or more Control Channel Elements, CCEs, in the CORESET as illustrated in FIG. 10. Further, one or more second PDCCH candidates for one or more further UEs using the partial CORESET are provided such that, for transmitting a second PDCCH candidate in the partial CORESET, a number of CCEs associated with different first PDCCH candidates is minimized. For example, in FIG. 10(a) for PDDCCH candidates of the Redcap UEs only the CCEs (shown as rectangular) of one PDDCH candidate of UE1 are used, while the CCEs (shown as circles and diamonds) are not employed. In FIG. 10(b) for the AL-8 PDDCCH candidates of the Redcap UE the CCEs (shown as rectangular and circle) of two PDDCH candidates of UE1 are used, while the CCEs (shown as diamonds) are not employed. Thus, the second PDCCH candidate may be provided such that, for transmitting the second PDCCH candidate in the partial CORESET, the CCEs for at least one of the first PDCCH candidates are not used for a second PDCCH candidate.

As is illustrated in FIG. 10(a), in case a first aggregation level of the first PDCCH candidate is higher than a second aggregation level of the second PDCCH candidate, the second PDCCH candidate is provided such that, for transmitting the second PDCCH candidate in the partial CORESET, only one or more CCEs associated with one first PDCCH candidate are used. On the other hand, as is illustrated in FIG. 10(b), in case a first aggregation level of the first PDCCH candidate is equal to a second aggregation level of the second PDCCH candidate, the second PDCCH candidate are provided such that, for transmitting the second PDCCH candidate in the partial CORESET, only one or more CCEs associated with two first PDCCH candidate are used.

Embodiments according to the second aspect provide for a wireless communication network, comprising:

one or more first user devices, UEs, and

one or more second user devices, UEs,

wherein the wireless communication network is to configure the first UE in a set of time symbols with a set of frequency resources for defining a control resource set, CORESET, and

wherein the wireless communication network is to configure the second UE in the set of time symbols with a subset of the frequency resources for defining a partial CORESET.

Embodiments according to the second aspect provide for a wireless communication network, wherein the wireless communication network is to configure a plurality of second UEs with the same subset of the frequency resources or with different subsets of the frequency resources.

Embodiments according to the second aspect provide for a wireless communication network, wherein, for configuring the second UE with the subset of the frequency resources, the wireless communication system is to signal to the second UE information describing the partial CORESET by
signaling all parameters of the CORSET and where the partial CORESET is located within the CORESET, e.g. by using an offset relative to a BWP of the second UE, or an offset relative to the starting point of the CORESET, or
signaling only parameters of the partial CORESET and additional parameters used to derive the structure of the partial CORESET, e.g. an offset of a first Control Channel Element, CCE, of the partial CORESET, and/or a DMRS offset, and/or an offset of the first RB of the partial CORESET.

Embodiments according to the second aspect provide for a wireless communication network, wherein, for configuring the second UE with the subset of the frequency resources, the wireless communication system is to signal to the second UE a frequency offset parameter indicating an offset of a first resource block, RB, of the partial CORESET, relative to a first RB of the CORSET, e.g. as a number of RBs or RB groups.

Embodiments according to the second aspect provide for a wireless communication network, wherein, for configuring the second UE with the subset of the frequency resources, the wireless communication system is to signal to the second UE a Demodulation Reference Signal, DMRS, offset, the DMRS offset enabling the second UE to reconstruct the part of the DMRS which falls into the partial CORESET.

Embodiments according to the second aspect provide for a wireless communication network, wherein, for configuring the second UE with the subset of the frequency resources, the wireless communication system is to signal to the second UE an Information Element, IE, containing CORESET IDs and corresponding offsets, the offsets including CORESET offsets and/or DMRS offsets.

Embodiments according to the second aspect provide for a wireless communication network, wherein, in case a physical downlink control channel, PDCCH, candidate for the second UE contains one or more Resource Element Group, REG, bundles fully or partly outside the partial CORSET, the second UE is to
drop the PDCCH candidate, or
if at least a certain number of REGs is fully within the partial CORESET, try to decode without the REGs outside the partial CORESET.

Embodiments according to the second aspect provide for a wireless communication network, wherein the wireless communication network is to map physical downlink control channel, PDCCH, candidates for the second UE by means of a hash function such that the PDCCH candidates lie within the partial CORESET, e.g., by setting a number of Control Channel Elements, CCEs, of the CORESET to the number of CCEs of the partial CORESET.

Embodiments according to the second aspect provide for a wireless communication network, wherein the wireless communication network is to signal a CCE offset to make sure the CCEs associated with the PDCCH candidates for the second UE lie within the partial CORESET.

Embodiments according to the second aspect provide for a wireless communication network, wherein the wireless communication network is to
provide one or more first PDCCH candidates for the first UE, each first PDCCH candidate to be transmitted on one or more Control Channel Elements, CCEs, in the CORESET, and
provide one or more second PDCCH candidates for the second UE such that, for transmitting a second PDCCH candidate in the partial CORESET, a number of CCEs associated with different first PDCCH candidates is minimized.

Embodiments according to the second aspect provide for a wireless communication network, wherein the wireless communication network is to provide the second PDCCH candidate such that, for transmitting the second PDCCH candidate in the partial CORESET, the CCEs for at least one of the first PDCCH candidates are not used for a second PDCCH candidate.

Embodiments according to the second aspect provide for a wireless communication network, wherein
in case a first number of CCEs of the first PDCCH candidate within the partial CORESET is higher than a second number of CCEs used for the second PDCCH candidate, the wireless communication network is to provide the second PDCCH candidate such that, for transmitting the second PDCCH candidate in the partial CORESET, only one or more CCEs associated with one first PDCCH candidate are used, or
in case a first number of CCEs of the first PDCCH candidate within the partial CORESET is equal to a second number of CCEs used for the second PDCCH candidate, the wireless communication network is to provide the second PDCCH candidate such that, for transmitting the second PDCCH candidate in the partial CORESET, only one or more CCEs associated with two first PDCCH candidate are used.

Embodiments according to the second aspect provide for a wireless communication network, wherein the second UE is capable to operate in a first frequency range or supports a first maximum bandwidth, and the first UE is capable to operate in a second frequency range or supports a second maximum bandwidth, the second frequency range or second maximum bandwidth being larger than the first frequency range or the first maximum bandwidth.

Embodiments according to the second aspect provide for a user device, UE, for a wireless communication network, wherein the wireless communication network provides in a set of time symbols a set of frequency resources defining a control resource set, CORESET,

wherein the UE is configured or preconfigured in the set of time symbols with a subset of the frequency resources for defining a partial CORESET.

Embodiments according to the second aspect provide for a user device, wherein the UE is capable to operate in a first frequency range or supports a first maximum bandwidth, the first frequency range or first maximum bandwidth being less than a second frequency range or a second maximum bandwidth of one or more further UEs configured with the plurality of CORESETs within the BWP.

Embodiments according to the second aspect provide for a method for operating wireless communication network, comprising one or more first user devices, UEs, and one or more second user devices, UEs, the method comprising:

configuring the first UE in a set of time symbols with a set of frequency resources for defining a control resource set, CORESET, and

configuring the second UE in the set of time symbols with a subset of the frequency resources for defining a partial CORESET.

Embodiments according to the second aspect provide for a method for operating a user device, UE, for a wireless communication network, wherein the wireless communication network provides in a set of time symbols a set of frequency resources defining a control resource set, CORESET, the method comprising:

### Third Aspect—Split PDCCH for Reduced Capability UEs

In accordance with embodiments of a third aspect of the present invention, UEs with a reduced capability or, more general, operating on a limited frequency range or bandwidth, may be provided with sufficiently encoded control messages, for example a DCI in accordance with an aggregation level, AL, at or above a predefined level, like AL-8 or higher. While such encoded control messages span a bandwidth beyond the bandwidth within which the UE2 is capable to operate, in accordance with embodiments of the third aspect of the present invention, the control message is split into two or more parts and transmitted at different occasions in time so that, once the last part is received, the reduced capability UE may combine the partial messages into the complete control message.

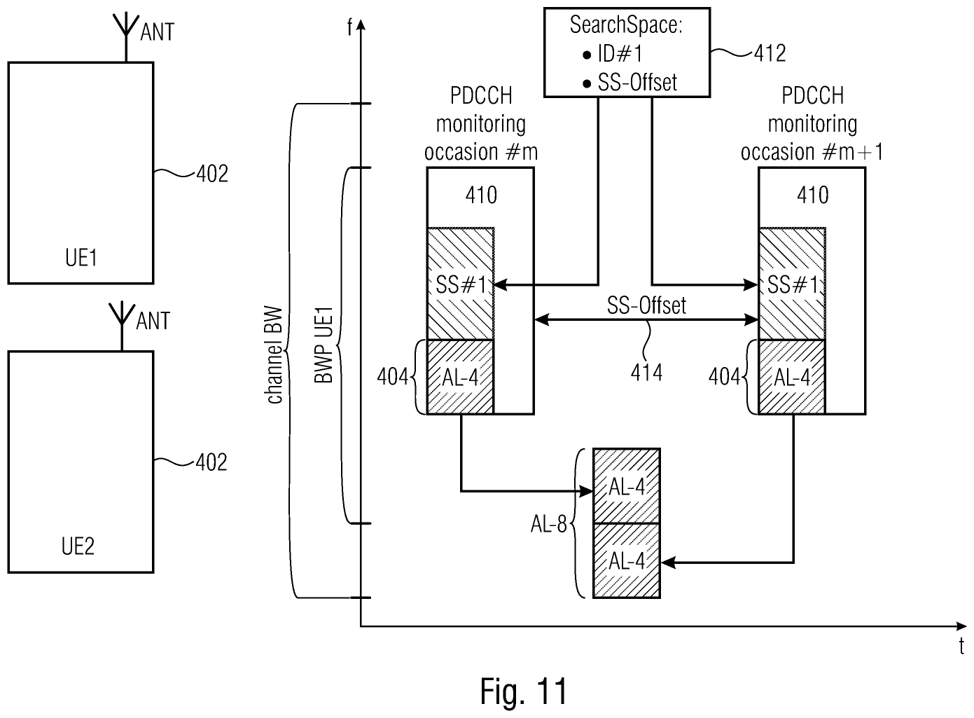

FIG. 11 illustrates an embodiment in accordance with the third aspect of the present invention. Like in FIG. 4 and FIG. 5, a network is illustrated including different types of UEs, namely UE1 400 and UE2 402. UE1, again, is assumed to operate over a first frequency range or bandwidth, which is larger than an operating bandwidth of UE2 which, for example, may be a reduced capability UE. The channel bandwidth is indicated within which a bandwidth part BWP is defined for UE1 which includes, in the depicted embodiment, a CORESET 410 that defines a PDCCH monitoring occasion. In FIG. 11, the PDDCH monitoring occasion is shown at two instances in time, namely at a first time #m and a second time #m+1. Within the CORESET, a search space is defined within which the PDCCH candidates are to be expected by UE1. For example, a partial CORESET 404 (see FIG. 5) may be defined within the search space SS#1. In the embodiment of FIG. 11 it is assumed that UE2, for example, is at a certain distance from a transmitter, like a gNB or another UE communicating to the UE2 via the sidelink, so that a robust and reliable coding is needed, and therefore, a control message directed to UE2 is encoded using a higher aggregation level. FIG. 11 illustrates an embodiment in which the control message is encoded using AL-8, however, the bandwidth of UE2 is not sufficient for transmitting such a message which, therefore, is split into two parts, as is indicated by AL-4 and is transmitted at occasion #m and at occasion #m+1. After receiving the second part of the control message UE2 combines the two parts into the complete control message AL-8. In a further embodiment, the PDCCH monitoring occasions #m and #m+1 and optionally further #m+i, may be regarded and/or processed as a single coupled monitoring occasion #m. For example, the possibility to regard multiple CORESETs at different frequency locations as a combined CORESET may be valid in the time domain for the monitoring occasions.

In other words, as depicted in FIG. 11, in accordance with embodiments of the third aspect of the present invention, certain larger aggregation levels, like AL-8 or AL-16, may be split across PDCCH monitoring occasions since a RedCap UE, like UE2, may not be able to process these larger ALs or has enough bandwidth to receive these larger ALs in one PDCCH monitoring occasion. Hence, the encoded control data is split into two or more parts and spread across multiple PDCCH monitoring locations which lowers the burden of UE2, and half of an AL-8 PDCCH is transmitted at the first occasion #m and the second half is transmitted at the second occasion #m+1 for reducing the frequency range within which UE2 has to receive. Nevertheless, UE2 still has to decode the complete AL-8 message.

In accordance with other embodiments, rather the splitting an AL-8 message, a corresponding message encoded using AL-4 may be transmitted twice, instead of transmitting an AL-8 message once. In such a scenario, UE2 may perform chase combining the both parts so that only decoding of an AL-4 message, instead of an AL-8 message is needed, thereby reducing the processing efforts.

In accordance with embodiments, UE2 may be configured with different search spaces which are indicated to be coupled, as is shown in FIG. 11 at 412, so that for a larger ALs, like AL-8 or AL-16, UE2 may use parts from both search spaces SS#1 for combining the information. In accordance with yet other embodiments, a search space offset 414 may be signaled, for example as part of a search space configuration, to indicate the location where the second parts of the PDCCH are located for a larger AL.

Conventionally, a reference time for certain control procedures is defined by the time the control message is received, i.e., at occasion #m. Based on the reference time certain time periods are defined, like the minimum time gap K0 between a DCI and the associated PDSCH, or the minimum time gap K2 between the DCI and the associated PUSCH, or the time between the DCI and the PUCCH with the corresponding HARQ-ACK, the so-called PDCCH-to-HARQ-timing. In accordance with embodiments implementing the splitting of control messages, the reference time is no longer occasion #m, but actually the last PDCCH monitoring occasion, like occasion #m+a in FIG. 11, that includes a part of the control message.

In accordance with embodiments, the coupled monitoring occasions may be applied only for larger ALs, like ALs at or above a certain threshold, or for all ALs regardless whether they are split across the monitoring occasions or not.

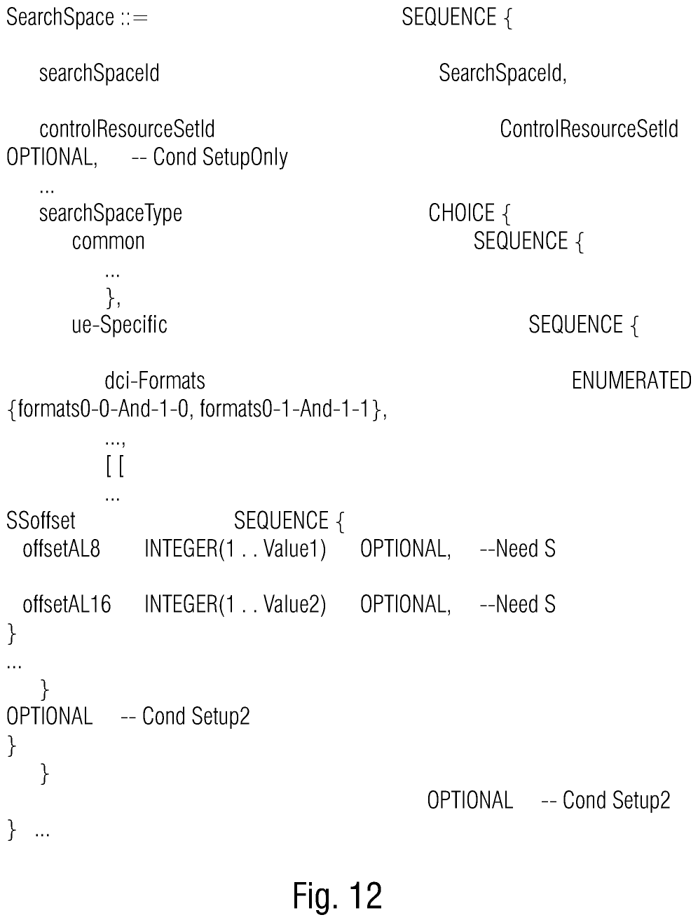

FIG. 12 depicts, in bold, an example of the specification of the timing offset for all DCI formats for a UE-specific search space that need to use higher aggregation levels 8 and 16. The offset for AL8 and/or AL16 may be in units of symbols or slots or subframes.

Embodiments according to the third aspect provide for a user device, UE, for a wireless communication network, wherein the wireless communication network provides a set of frequency and time resources defining a monitoring occasion, like a PDCCH monitoring occasion, for transmitting one or more control messages, like a DCI,

wherein the UE is to receive a control message across a plurality of monitoring occasions which are offset in time, each monitoring occasion including a part of the control message, and

wherein the UE is to combine the received parts of the control message into the complete control message.

Embodiments according to the third aspect provide for a user device, wherein the UE is configured or preconfigured with a plurality of search spaces which are indicated to be coupled, each of the coupled search spaces associated with a monitoring occasion including a part of the control message.

Embodiments according to the third aspect provide for a user device, wherein the UE is configured or preconfigured with a search space configuration including a time offset indicating the monitoring occasions where the parts of the control message are located.

Embodiments according to the third aspect provide for a user device, wherein the monitoring occasions are a physical downlink control channel, PDCCH, monitoring occasion, and wherein the parts of the control messages are encoded with an aggregation level.

Embodiments according to the third aspect provide for a user device, wherein a reference time for other control procedures, like a minimum time gap between a DCI and a PDSCH, or a minimum time gap between a DCI and a PUSCH, or a time between a DCI and a PUCCH with a corresponding HARQ-ACK, is a last monitoring occasion containing a part of the control message for all aggregation levels or for a part of aggregation levels, e.g. only the ones split across multiple monitoring occasions, or for certain configured or preconfigured DCI formats or for certain search spaces, e.g. search spaces indicating multiple monitoring occasions.

Embodiments according to the third aspect provide for a user device, wherein the UE is capable to operate in a first frequency range or supports a first maximum bandwidth, the first frequency range or first maximum bandwidth being less than a second frequency range or a second maximum bandwidth of one or more further UEs operating in the wireless communication network.

Embodiments according to the third aspect provide for a user device, wherein the plurality of monitoring occasions which are offset in time are processed as a single monitoring occasion by the UE.

Embodiments according to the third aspect provide for a wireless communication network, comprising one or more user devices, UEs, of the third aspect.

Embodiments according to the third aspect provide for a method for operating a user device, UE, for a wireless communication network, wherein the wireless communication network provides a set of frequency and time resources defining a monitoring occasion, like a PDCCH monitoring occasion, for transmitting one or more control messages, like a DCI, the method comprising:

receiving a control message, with the UE, across a plurality of monitoring occasions which are offset in time, each monitoring occasion including a part of the control message, and

combining, with the UE, the received parts of the control message into the complete control message.

### Fourth Aspect—Limited Search Space Configuration for RedCap UEs

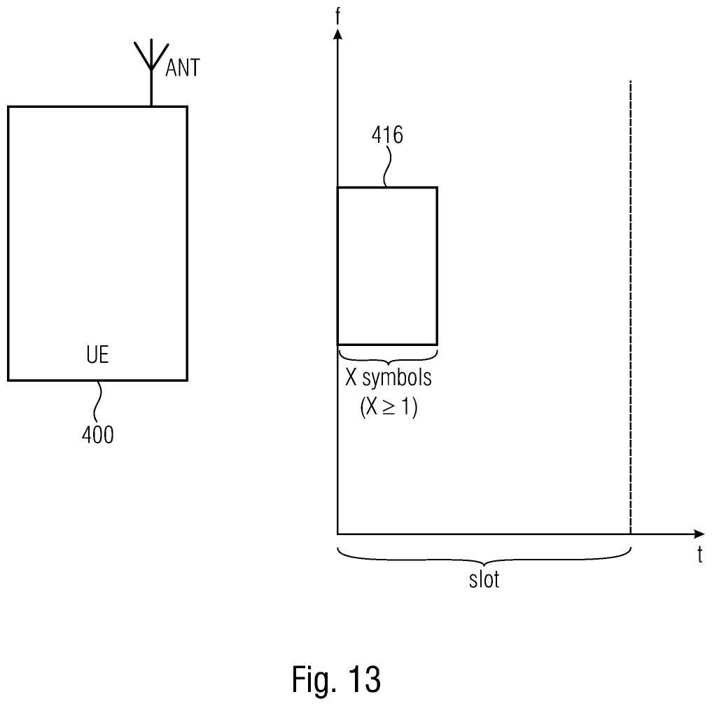

In accordance with embodiments of a fourth aspect of the present invention, for UEs having a reduced capability, the location of a CORESET within a time slot may be such that the CORESET is located at a predefined set of time symbols within the slot, for example at the first OFDM symbols of the slot, or the set of time symbols of all CORESETs may be aligned, for example all CORESETs may be located at the same set of time symbols within a slot, i.e., the CORESET may be at a configured or preconfigured set of time symbols within a slot where the set of time symbols is equal across all CORESET configuration. FIG. 13 illustrates an embodiment of the fourth aspect of the present invention, more specifically, a wireless network and the UE operating in accordance with this aspect. As is illustrated, a UE 400, which is a reduced capability UE, is configured or preconfigured with a set of frequency resources that span a frequency range being equal to or less than the bandwidth on which the UE 400 is capable of operating, and these frequency resources define the CORESET 416 in such a way that it is located at a predefined set of time symbols within a slot, for example at the first X symbols of the slot with X being greater than or equal to 1.

In accordance with the fourth aspect of the present invention, restricting the CORESET and search space flexibility by placing the CORESET at the above-described location within a slot, is beneficial as it allows reducing the complexity of UE 400. For example, conventionally, the CORESET may be located anywhere within the slot, however, restricting the CORESET, for example, to the first three OFDM symbols of the slot is beneficial simplify the planning of the UE. Since by restricting the CORESET timing the gap between a DCI scheduling a DL assignment or UL grant stays the same. Moreover, UE 400 may not support small search space periodicities, as this increases the burden on the UE which has to monitor PDCCH frequently so that in accordance with embodiments, larger periodicities when compared to other UEs operating in a broader bandwidth, like eMBB UEs, is implemented in accordance with an embodiment of the fourth aspect. Thus, in accordance with embodiments of the fourth aspect, for reducing the complexity of UE 400, the time symbols within a slot, at which a CORESET is located, are restricted to a subset of the overall number of symbols within the slot, like the first X OFDM symbols of the slot with X being greater than or equal to 1 and less than the overall number of symbols in the slot. Further, small monitoring periodicities for search spaces are not provided, rather larger periodicities are implemented for UE 400. For example, existing IEs, like controlResourceSet and SearchSpace and the fields duration specified for a particular controlResourceSetId and monitoringSymbolsWithinSlot may be used in accordance with embodiments to specify the time symbols where monitoring is be applied.

Embodiments according to the fourth aspect provide for a wireless communication network, comprising:

one or more first user devices, UEs, and

one or more second user devices, UEs,

wherein the wireless communication network is to configure the first UE with a set of frequency resources defining a first control resource set, CORESET, such that the first CORESET is located at an arbitrary set of time symbols within a slot, and

wherein the wireless communication network is to configure the second UE with a set of frequency resources defining a second control resource set, CORESET, such that the second CORESET is located at a predefined set of time symbols within a slot, e.g., at the first OFDM symbols of the slot, and/or at a configured or preconfigured set of time symbols within a slot where the set of time symbols is equal across all CORESET configurations.

Embodiments according to the fourth aspect provide for a wireless communication network, wherein the wireless communication network is to configure search spaces in the first CORSET for a first UE with a first periodicity, and search spaces in the second CORSET for a second UE with a second periodicity, the smallest second periodicity being larger than the smallest first periodicity.

Embodiments according to the fourth aspect provide for a wireless communication network, wherein the second UE is capable to operate in a first frequency range or supports a first maximum bandwidth, and the first UE is capable to operate in a second frequency range or supports a second maximum bandwidth, the second frequency range or second maximum bandwidth being larger than the first frequency range or the first maximum bandwidth.

Embodiments according to the fourth aspect provide for a method for operating a wireless communication network comprising one or more first user devices, UEs, and one or more second user devices, UEs, the method comprising:

configuring the first UE with a set of frequency resources defining a first control resource set, CORESET, such that the first CORESET is located at an arbitrary set of time symbols within a slot, and

configuring the second UE with a set of frequency resources defining a second control resource set, CORESET, such that the second CORESET is located at a predefined set of time symbols within a slot, e.g., at the first OFDM symbols of the slot, and/or at a configured or preconfigured set of time symbols within a slot where the set of time symbols is equal across all CORESET configurations.

In connection with each of the first to fourth aspect, embodiments provide for a wireless communication network, wherein the wireless communication network further comprises one or more further UEs or an entity of the core network or the access network of the wireless communication network.

In connection with each of the first to fourth aspect, embodiments provide for a wireless communication network, wherein the entity of the core network or the access network comprises one or more of the following: a macro cell base station, or a small cell base station, or a central unit of a base station, or a distributed unit of a base station, or a road side unit, RSU, or an AMF, or an MME, or an SMF, or a core network entity, or mobile edge computing, MEC entity, or a network slice as in the NR or 5G core context, or any transmission/reception point, TRP, enabling an item or a device to communicate using the wireless communication network, the item or device being provided with network connectivity to communicate using the wireless communication network.

In connection with each of the first to fourth aspect, embodiments provide for a user device, UE, wherein the user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and using input from a gateway node at periodic intervals, or a mobile terminal, or a stationary terminal, or a cellular IoT-UE, or a vehicular UE, or a vehicular group leader (GL) UE, or an IoT or narrowband IoT, NB-IoT, device, a wearable, a reduced capability (RedCap) device, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

### General

Although the respective aspects and embodiments of the inventive approach have been described separately, it is noted that each of the aspects/embodiments may be implemented independent from the other, or some or all of the aspects/embodiments may be combined. Moreover, the subsequently described embodiments may be used for each of the aspects/embodiments described so far.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and using input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Embodiments of the present invention provide a computer program product comprising instructions which, when the program is executed by a computer, cause the computer to carry out one or more methods in accordance with the present invention.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

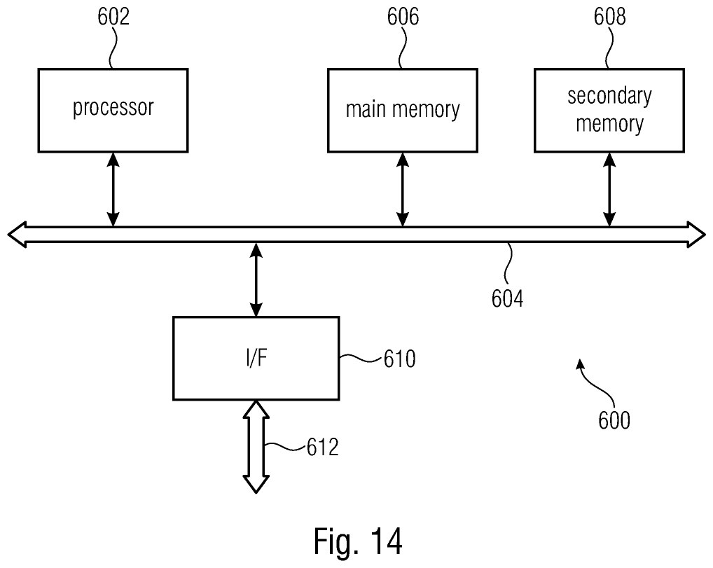

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 14 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1-46. (canceled)

47. A user device, UE, for a wireless communication network, wherein the wireless communication network provides a set of frequency and time resources defining a monitoring occasion, like a PDCCH monitoring occasion, for transmitting one or more control messages, like a DCI,
wherein the UE is to receive a control message across a plurality of monitoring occasions which are offset in time, each monitoring occasion including a part of the control message, and
wherein the UE is to combine the received parts of the control message into the complete control message.

48. The user device, UE, of claim 47, wherein the UE is configured or preconfigured with a plurality of search spaces which are indicated to be coupled, each of the coupled search spaces associated with a monitoring occasion including a part of the control message.

49. The user device, UE, of claim 47, wherein the UE is configured or preconfigured with a search space configuration including a time offset indicating the monitoring occasions where the parts of the control message are located.

50. The user device, UE, of claim 47, wherein the monitoring occasions are a physical downlink control channel, PDCCH, monitoring occasion, and wherein the parts of the control messages are encoded with an aggregation level.

51. The user device, UE, of claim 47, wherein a reference time for other control procedures, like a minimum time gap between a DCI and a PDSCH, or a minimum time gap between a DCI and a PUSCH, or a time between a DCI and a PUCCH with a corresponding HARQ-ACK, is a last monitoring occasion containing a part of the control message for all aggregation levels or for a part of aggregation levels, e.g. only the ones split across multiple monitoring occasions, or for certain configured or preconfigured DCI formats or for certain search spaces, e.g. search spaces indicating multiple monitoring occasions.

52. The user device, UE, of claim 47, wherein the UE is capable to operate in a first frequency range or supports a first maximum bandwidth, the first frequency range or first maximum bandwidth being less than a second frequency range or a second maximum bandwidth of one or more further UEs operating in the wireless communication network.

53. The user device, UE, of claim 47, wherein the plurality of monitoring occasions which are offset in time are processed as a single monitoring occasion by the UE.

54. The user device, UE, of claim 47, wherein the user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader (GL) UE, or an loT or narrowband IoT, NB-IoT, device, a wearable, a reduced capability (RedCap) device, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

55. A wireless communication network, comprising one or more user devices, UEs, of claim 47.

56. The wireless communication network of claim 55, wherein the wireless communication network further comprises one or more further UEs or an entity of the core network or the access network of the wireless communication network.

57. The wireless communication network of claim 56, wherein the entity of the core network or the access network comprises one or more of the following: a macro cell base station, or a small cell base station, or a central unit of a base station, or a distributed unit of a base station, or a road side unit, RSU, or an AMF, or an MME, or an SMF, or a core network entity, or mobile edge computing, MEC entity, or a network slice as in the NR or 5G core context, or any transmission/reception point, TRP, enabling an item or a device to communicate using the wireless communication network, the item or device being provided with network connectivity to communicate using the wireless communication network.

58. A method for operating a user device, UE, for a wireless communication network, wherein the wireless communication network provides a set of frequency and time resources defining a monitoring occasion, like a PDCCH monitoring occasion, for transmitting one or more control messages, like a DCI, the method comprising: receiving a control message, with the UE, across a plurality of monitoring occasions which are offset in time, each monitoring occasion including a part of the control message, and
combining, with the UE, the received parts of the control message into the complete control message.
